(19) United States
(12) Patent Application Publication
(10) Pub. No.: US 2010/0186017 A1
(43) Pub. Date: Jul. 22, 2010

(54) System and method for medical image processing

(76) Inventors: Raghavendra Eeratta, Bangalore (IN); Manjunath Hegde, Bangalore (IN); Shiva Murthi, Bangalore (IN); Sanath Shenoy, Bangalore (IN)

Correspondence Address: HARNESS, DICKEY & PIERCE, P.L.C., P.O. BOX 8910, RESTON, VA, 20195, US

(21) Appl. No.: 12/320,193

(22) Filed: Jan. 21, 2009

(51) Int. Cl. G06F 9/46; G06T 1/00; G06F 15/16

(52) U.S. Cl. 718/104; 705/3; 345/522; 709/205

(57) ABSTRACT

An embodiment of the present invention provides a system and method for medical image processing. The proposed system includes a grid computing framework adapted for receiving patient data including one or more patient-scan images from an end-user application, and for scheduling image processing tasks to a plurality of nodes of a grid computing network. Each of the nodes includes a central processing unit and at least one of the nodes includes programmable graphics processing unit hardware. The proposed system further includes a second framework for image processing using graphics processing unit that is operative on each node of the network. The second framework operative on any node is adapted to execute the image processing task scheduled to that node based upon the availability of graphics processing unit hardware in that node. When graphics processing unit hardware is available in the node, the second framework is adapted to execute the task on the graphics processing unit of the node using stream computation. When graphics processing unit hardware is not available in the node, the second framework is adapted to execute the task on the central processing unit of the node.

### FIELD OF INVENTION

The present invention relates to image processing for medical applications.

### BACKGROUND OF INVENTION

Medical image processing usually involves highly computationally intensive tasks on large image datasets. Typical tasks in the domain include, but are not limited to, image registration, reconstruction, preprocessing, segmentation and visualization. All these tasks are computationally intensive. Also, the image datasets are extremely large, which compounds the computations required to achieve a particular result for the end user, typically a doctor/radiologist. Most of these tasks are performed on stand-alone, expensive computers.

One way of improving the performance of a complex task is to employ a split-and-aggregate method of processing the data. For example, when repetitive tasks are required to be performed on a large series of images, the series can be split into a number of sub-series' and processed independently on individual PCs during their idle-time (i.e. when clock-cycles are available) from a central computer that manages data scheduling and result managing. The results from the PCs where the actual processing is performed are then aggregated at central computer and returned to the application. This is the principle behind grid computing.

Another approach to improving the performance of medical image processing tasks is to employ custom-hardware called graphics processing units (GPU). Originally intended for the consumer game industry to render high-quality graphics quickly, GPUs are adapted for a mode of computing known as stream computing. In this technique, the same operation or instruction is performed on different data in parallel. This is also known as the single instruction multiple data (SIMD) model.

It is desirable to achieve further improvement in the performance of medical image processing tasks.

### SUMMARY OF INVENTION

The present invention provides a novel image processing technique combining the capabilities of grid computing and GPU based stream computation to achieve higher performance and lower execution times. In one aspect of the present invention a system for medical image processing is proposed. The proposed system comprises a grid computing framework adapted for receiving patient data comprising one or more patient-scan images from an end-user application, and for scheduling image processing tasks to a plurality of nodes of a grid computing network. Each of said nodes comprises a central processing unit and at least one of said nodes comprises programmable graphics processing unit hardware. The proposed system further comprises a second framework for image processing using graphics processing unit that is operative on each node of said network. The second framework operative on any node is adapted to execute the image processing task scheduled to that node based upon the availability of graphics processing unit hardware in that node. When graphics processing unit hardware is available in said node, the second framework is adapted to execute said task on the graphics processing unit of said node using stream computation. When graphics processing unit hardware is not available in said node, the second framework is adapted to execute said task on the central processing unit of said node.

In another aspect of the present invention, a method for medical image processing is proposed. The proposed method comprises receiving patient data comprising one or more patient-scan images from an end-user application and scheduling image processing tasks to a plurality of nodes of a grid computing network, wherein each of said nodes comprises a central processing unit and at least one of said nodes comprises programmable graphics processing unit hardware. The proposed method further comprises executing the image processing task scheduled to a node based upon the availability of graphics processing unit hardware in that node, wherein said task is executed on the graphics processing unit of said node using stream computation when graphics processing unit hardware is available in said node, and wherein said task is executed on the central processing unit of said node when graphics processing unit hardware is not available in said node.

### BRIEF DESCRIPTION OF THE DRAWINGS

The present invention is further described hereinafter with reference to exemplary embodiments shown in the accompanying drawings, in which:

FIG. 1 is a block diagram illustrating a system for medical image processing,

FIG. 2 is a graph for comparatively illustrating execution times of CPU, grid, and grid-GPU modes for carrying out Gaussian blur algorithm on different medical stored in DICOM format, and

FIG. 3 is a graph showing the comparison of the normalized root mean squared error (NRMSE) between the outputs of the CPU and GPU modes for executing a Gaussian blur algorithm for DICOM 10 series images

### DETAILED DESCRIPTION OF INVENTION

As mentioned above, the present invention provides a novel image processing technique combining the capabilities of grid computing and GPU based stream computation to achieve higher performance and lower execution times. An embodiment of the present invention also provides a software-as-a-service (SaaS) framework for providing a web-based service for image processing and patient diagnosis to the end-user application.

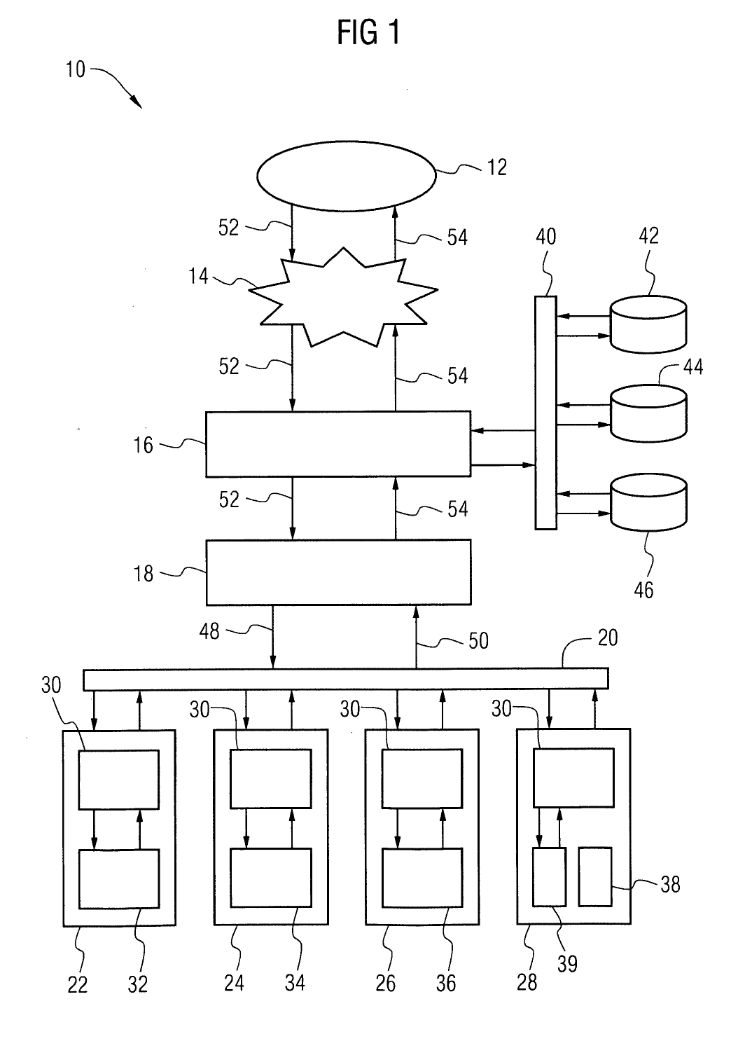

FIG. 1 illustrates a system 10 for medical image processing in accordance with one embodiment of the present invention. The system 10 includes a grid computing framework 18 for receiving patient data 52 from an end-user application 12 via communication link 14. The end-user application may be operated by a doctor/radiologist at a clinic. The patient data 52 comprises one or more patient-scan images of any modality, including, but not limited to, computed tomography (CT), single photon emission computed tomography (SPECT), magnetic resonance imaging (MRI), ultrasound (US), positron emission tomography (PET), among others, stored typically in one or more DICOM (digital imaging and communications in medicine) files. In the illustrated embodiment, the end-user application 12 is remote to the grid computing framework 18, and the communication link 14 comprises, for example, the Internet.

Upon receiving the patient data 52, the grid computing framework 18 schedules image processing tasks 48 to a plurality of nodes 22, 24, 26, 28 (which are typically PCs) connected to a grid computing network 20, based on a split-and-aggregate method. Each of the nodes 22, 24, 26, 28 comprises respective central processing units (CPUs) 32, 34, 36, 38 and may or may not include GPU hardware. As shown in the illustrated embodiment, at least one node 28 in the grid comprises a GPU 39. The tasks 48 include, for example, image registration, reconstruction, preprocessing, segmentation and visualization, among others. These tasks are processed independently on the nodes 22, 24, 26, 28 using medical image processing (MIP) libraries, and the results from these nodes is aggregated to yield processed patient data 50, which is returned to the end-user-application 12.

In accordance with the present invention, a second framework 30 is provided. This second framework 30, also referred to as IPGPU (image processing using GPU) framework, works over the grid computing network 20 utilizing the hardware (i.e. the PCs or the nodes 22, 24, 26, 28) available on the grid. The IPGPU framework 30 is adapted to execute the image processing task scheduled to a node based upon the availability of graphics processing unit hardware in that node. As shown in FIG. 1, when the nodes are GPU-enabled, i.e. have programmable and compatible graphics cards attached, the IPGPU framework 30 will execute the tasks on the GPUs. When GPUs are not available on a node, the tasks will be executed on the CPU of that node. That is, the IPGPU software framework runs on the CPU of individual nodes and invokes algorithms on GPU when GPU hardware is available in the node. The IPGPU framework 30 is extendable (algorithmically) along two orthogonal paths, namely, the traditional serial-CPU algorithms and the stream-GPU algorithms. The results of the algorithms are equivalent, and the choice of which one is employed is decided by the IPGPU framework 30 based on various considerations such as availability of hardware, data transmission costs, associated hardware costs, etc. The IPGPU framework 30 maintains a level of abstraction that does not expose any of the intricate operations such as memory management, exception-handling, logging, data handling, etc. to the end-user application 12.

In a preferred embodiment of the present invention, the grid computing framework 18 also communicates with a data archival grid 40 comprising a plurality of distributed picture archival and communication systems (PACS) 42, 44, 46 to store processed patient data. Thus in this embodiment, there are two logical grids that the grid computing framework 18 accesses, namely, the grid computing network 20 that interacts with the IPGPU framework 30, and the data archival grid 40 that interacts with the distributed PACS environment. This embodiment advantageously enables future diagnosis on previously treated patients (whose data has been archived) to be even faster, since the clinician would have to only transmit the new data and the system would read the prior history from the PACS. With the user's permissions, data stored in the PACS could be used to further improve the diagnostic accuracy of the image processing algorithms (with the “ideal” result being human markup for comparison and learning).

The proposed idea may be extended to provide a web-based image processing and patient diagnosis service that provides high-performance computing. To that end, a software-as-a-service (SaaS) framework 16 may be provided over the grid computing framework 18. The SaaS framework 16 caters to functions such as user authentication, service listings, and payments, among others. The end-user (doctor/radiologist) would simply have to send images over a network (via the web-service) for processing. The grid computing framework 18 will split-and-aggregate and process the image(s) over the grid and on the CPU/GPUs that make up the grid (via the IPGPU Framework) and return the results to the end-user. The end-user can be charged for the service based on the intensity of the processing required and “volume of data to be processed.

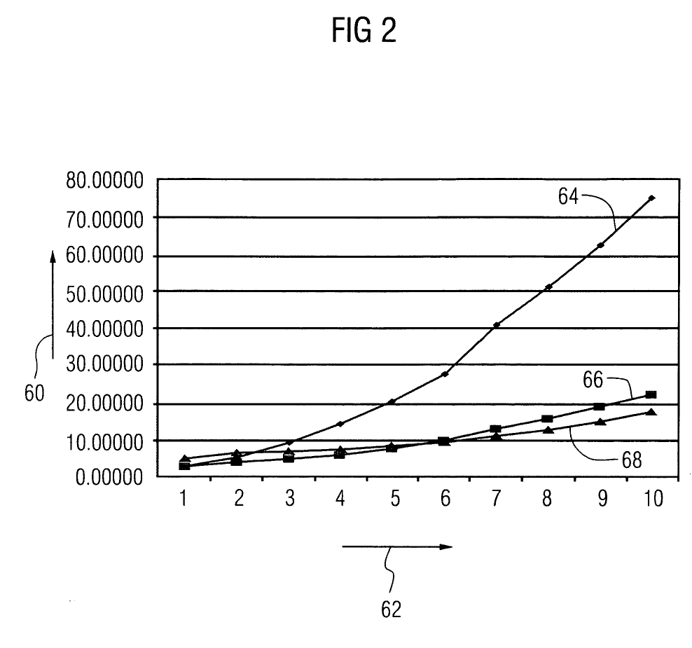

The use of the IPGPU framework in the grid environment thus provides fast and accurate execution of complex medical image processing algorithms, especially when the algorithms are executed in the GPU mode). FIG. 2 shows execution time comparisons between serial (i.e., CPU, grid, and grid-GPU modes in executing Gaussian blur algorithm. The graph shows the variation of execution time (in seconds, represented along the axis 60) as a function of variance of Gaussian kernel (referred to as ‘σ’ or sigma, and represented along the axis 62). It should be noted that as σ increases, the filter mask size also increases, requiring increased processing. The curve 64 represents this variation when the algorithm is executed in a single CPU. The curve 66 represents plot in case of a grid having 4 CPUs. The curve 68 represents the plot in case of a grid having 4 PCs out of which one PC comprises a GPU. As can be seen, execution time is least in the grid-GPU mode of execution.

Table 1 below shows the comparison of the execution time performance between the three execution modes. Three different datasets are chosen, namely the DICOM 10, 50 and 100 series. For two different values of σ, timing experiments were performed on a single machine (without a GPU) [1/0], a 4-executor grid (also without any GPUs) [4/0] and a 4-executor grid with one of the machines having a GPU [4/1]. The last two columns indicate the time scaling achieved by employing the Grid and Grid-GPU methods over the traditional CPU (i.e. serial) method. In table 1, the first number inside the bracket represents the number of PCs, while the second number represents the number of PCs with GPU.

TABLE 1

| DICOM | | | | | Time-Scale | Time-Scale |
|---|---|---|---|---|---|---|
| Series | | | | | Factor (X) | Factor (X) |
| (Number of | | T_CPU | T_grid | T_GRIDGPU | T_CPU v/s | (T_CPU vs |
| images) | σ | [1/0] (sec) | [4/0] (sec) | [4/1] (sec) | T_grid | T_gridGPU) |
| 10 | 5 | 17 | 7.8924 | 8.3769 | 2.153970909 | 2.029390347 |
| 10 | 10 | 65 | 22.0362 | 17.5664 | 2.949691871 | 3.700245924 |
| 50 | 5 | 79 | 30.3924 | 34.7372 | 2.599334044 | 2.274218993 |
| 50 | 10 | 375 | 90.174 | 74.7361 | 4.158626655 | 5.017655457 |
| 100 | 5 | 177 | 67.4014 | 87.2623 | 2.626058212 | 2.028367348 |
| 100 | 10 | 729 | 191.9821 | 133.7947 | 3.797229012 | 5.448646322 |

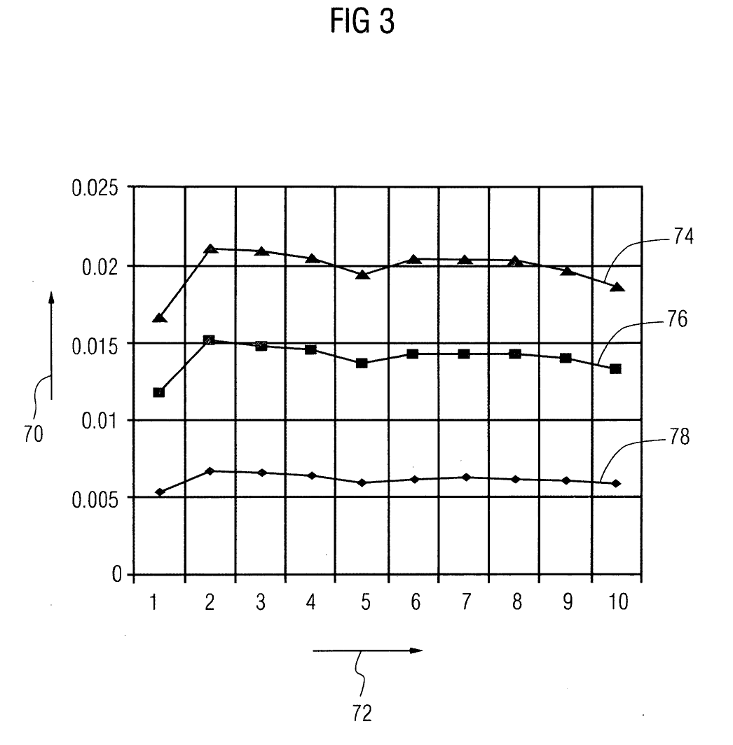

FIG. 3 is a graph showing the comparison of the normalized root mean squared error (NRMSE) between the outputs of the CPU and GPU modes for executing a Gaussian blur algorithm for DICOM 10 series images for different values of σ (sigma). Herein, the NRMSE (%) is plotted along the axis 70, and the number of images is represented along the axis 72. The curves 74, 76 and 78 are respectively obtained for σ=1, σ=5 and σ=10.

Summarizing, the present invention of the present invention relates to a system and method for medical image processing is proposed. The proposed system comprises a grid computing framework adapted for receiving patient data comprising one or more patient-scan images from an end-user application, and for scheduling image processing tasks to a plurality of nodes of a grid computing network. Each of said nodes comprises a central processing unit and at least one of said nodes comprises programmable graphics processing unit hardware. The proposed system further comprises a second framework for image processing using graphics processing unit that is operative on each node of said network. The second framework operative on any node is adapted to execute the image processing task scheduled to that node based upon the availability of graphics processing unit hardware in that node. When graphics processing unit hardware is available in said node, the second framework is adapted to execute said task on the graphics processing unit of said node using stream computation. When graphics processing unit hardware is not available in said node, the second framework is adapted to execute said task on the central processing unit of said node.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. Accordingly, it is intended that the invention be limited only by the spirit and scope of the appended claims.

1. A system for medical image processing, comprising:
a grid computing framework adapted for receiving patient data comprising one or more patient-scan images from an end-user application, and for scheduling image processing tasks to a plurality of nodes of a grid computing network, wherein each of said nodes comprises a central processing unit and at least one of said nodes comprises programmable graphics processing unit hardware; and
a second framework for image processing using graphics processing unit that is operative on each node of said network, said second framework being adapted to execute the image processing task scheduled to that node based upon the availability of graphics processing unit hardware in that node, wherein said second framework is adapted to execute said task on the graphics processing unit of said node using stream computation when graphics processing unit hardware is available in said node, and is adapted to execute said task on the central processing unit of said node when graphics processing unit hardware is not available in said node.

2. The system of claim 1, wherein said grid computing framework is further adapted to communicate with a data archival grid comprising a plurality of distributed picture archival and communication systems adapted for storing processed patient data.

3. The system according to claim 1, wherein said end-user application accesses said grid computing framework via a software-as-a-service framework adapted for providing web-based medical image processing service to the end-user.

4. A method for medical image processing, comprising:
receiving patient data comprising one or more patient-scan images from an end-user application;
scheduling image processing tasks to a plurality of nodes of a grid computing network, wherein each of said nodes comprises a central processing unit and at least one of said nodes comprises programmable graphics processing unit hardware; and
executing the image processing task scheduled to a node based upon the availability of graphics processing unit hardware in that node, wherein said task is executed on the graphics processing unit of said node using stream computation when graphics processing unit hardware is available in said node, and wherein said task is executed on the central processing unit of said node when graphics processing unit hardware is not available in said node.

5. The method of claim 4, further comprising storing processed patient data in a data archival grid in communication with said grid computing network

6. A method for providing a web-based medical image processing service in accordance with the method of claim 4.
